(19) United States
(12) Patent Application Publication
(10) Pub. No.: US 2021/0323383 A1
(43) Pub. Date: Oct. 21, 2021

(54) FRAGRANCE DIFFUSER FOR VEHICLE

(71) Applicants: Hyundai Motor Company, Seoul (KR); Kia Motors Corporation, Seoul (KR); Sung Chang Autotech Co., Ltd., Anseong (KR); Hanon Systems, Daejeon (KR)

(72) Inventors: Young-Su Nam, Seoul (KR); Tae-Kun Kim, Ansan (KR); Dong-Won Yeon, Daejeon (KR); Sang-Jin Park, Anseong (KR); Han-Soon Choi, Anseong (KR); Jong-Gon Lee, Daejeon (KR); Won-Seok Song, Anseong (KR); Yong-Eun Seo, Daejeon (KR); Sang-Chul Byun, Daejeon (KR)

(21) Appl. No.: 17/103,464

(22) Filed: Nov. 24, 2020

(30) Foreign Application Priority Data
Apr. 16, 2020 (KR) 10-2020-0046255

(51) Int. Cl. B60H 3/00

(52) U.S. Cl. CPC B60H 3/0035; B60H 2003/0064

(57) ABSTRACT

A fragrance diffuser for a vehicle has a structure separate from an air conditioning operation of a vehicle and may selectively emit a fragrance stored in a plurality of cartridges by an opening/closing device. The fragrance diffuser includes: a plurality of cartridges each including: a casing having an internal space configured to store a fragrance; and an opening/closing member extending to communicate with an interior and an exterior of the casing, and configured to open or close the internal space; a housing including: an inlet; a movement passage for the air; insertion ports into which the cartridges are inserted in the movement passage; and an outlet from which the fragrance or the air is discharged depending on an opened or closed state of each of the cartridges; an opening/closing device configured to operate the opening/closing members; and a control unit configured to control an operation of the opening/closing device.

### CROSS-REFERENCE TO RELATED APPLICATION(S)

This application claims under 35 U.S.C. § 119 the benefit of Korean Patent Application No. 10-2020-0046255, filed on Apr. 16, 2020 in the Korean Intellectual Property Office, the entire contents of which are incorporated herein by reference.

### BACKGROUND

### 1. Technical Field

The present disclosure relates to a fragrance diffuser for a vehicle, more particularly, to the fragrance diffuser having a structure separate from an air conditioning operation of a vehicle and which may selectively emit a fragrance stored in a plurality of cartridges by use of an opening/closing device.

### 2. Description of the Related Art

In general, an air conditioning device for a vehicle refers to a device installed in the vehicle to cool or heat an interior of the vehicle and/or to remove moisture in the interior of the vehicle.

In accordance with independent structures of a blower unit, an evaporator unit, and a heater core unit, the air conditioning device for a vehicle may be classified into a three-piece type air conditioning device in which the three units are independently provided, a semi-center type air conditioning device in which the evaporator unit and the heater core unit are embedded in an air conditioning casing and the blower unit is provided as a separate unit, and a center mounting type air conditioning device in which all of the three units are embedded in the air conditioning casing.

Meanwhile, when the air conditioning device operates to cool or heat the interior of the vehicle while the vehicle travels, various types of harmful substances such as soot and smoke gas or dust produced from a road are mixed with outside air and introduced into the interior of the vehicle.

When the air conditioning device operates on a humid day, offensive odor may be generated by bacterial foreign substances such as mold that inhabit an air conditioning duct, which may cause discomfort to a vehicle occupant.

Recently, in order to solve the aforementioned problem, a fragrance supply device is mounted at one side of the air conditioning device and purifies air in the interior of the vehicle. As an example, a fragrance generating device disclosed in Korean Patent Application Laid-Open No. 10-2013-0100509 (entitled Fragrance Generating Device for Vehicle and Method of Controlling Same) includes a cartridge configured to store a fragrance; a supply unit connected to the cartridge and having an inlet into which aroma of the fragrance is introduced, an outlet from which the introduced fragrance is discharged, and an inner flow path configured to allow the inlet and the outlet to communicate with each other; an opening/closing device coupled to the supply unit and configured to selectively open or close the inlet or the outlet; and a control unit connected to the opening/closing device and configured to control an operation of the opening/closing device.

However, Korean Patent Application Laid-Open No. 10-2013-0100509 discloses a structure in which the discharged fragrance flows into an HVAC (heating, ventilation, air conditioning) blower, and as a result, there is concern that the generation of the fragrance deteriorates when a water soluble liquid contained in the fragrance is dissolved in a condensate water in an air conditioner for HVAC.

### SUMMARY

The present disclosure provides a new type of fragrance diffuser for a vehicle, which has a structure separate from an air conditioning operation of the vehicle, does not cause concern of a deterioration in fragrance generation, and may selectively emit a fragrance, which is desired by a user, from a plurality of cartridges through a simple shaft-cam structure.

In order to achieve the above-mentioned object, the present disclosure provides a fragrance diffuser for a vehicle, the fragrance diffuser including: a plurality of cartridges each including: a casing having an internal space configured to store a fragrance; and an opening/closing member extending to communicate with an interior and an exterior of the casing, connected elastically movably to the casing, and configured to open or close the internal space depending on a moved state of the opening/closing member; a housing including: an inlet into which air is introduced by a blower mounted at one side of the housing; a movement passage for the air; insertion ports into which the cartridges are inserted in the movement passage; and an outlet from which the fragrance or the air is discharged depending on an opened or closed state of each of the cartridges; an opening/closing device configured to operate the opening/closing members; and a control unit configured to control an operation of the opening/closing device.

According to the present disclosure, the following effects are achieved.

First, in a case in which a fragrance diffuser is constituted by using an HVAC (heating, ventilation, air conditioning) blower in the related art, there is concern that the generation of the fragrance may deteriorate because there is a likelihood that water soluble substances contained in an undiluted fragrance solution are dissolved in condensate water in an air conditioner. However, according to the present disclosure, the separate independent blower is used and thus operates regardless of an air conditioning operation, and as a result, it is possible to prevent a problem of a deterioration in generation of fragrance.

Second, a shaft-cam structure is applied as the opening/closing device, and as a result, a structure may be simplified, thereby reducing maintenance and production costs.

Third, the fragrances stored in the respective cartridges may be selectively discharged depending on the positions of the control cams which are changed in accordance with the rotation of the shaft.

Fourth, the concentration of the fragrance to be discharged may be adjusted by controlling the positions of the control cams.

### BRIEF DESCRIPTION OF THE DRAWINGS

FIG. 1 is a view illustrating an overall appearance of a fragrance diffuser for a vehicle according to an exemplary embodiment of the present disclosure.

FIG. 2 is a view illustrating a state in which an opening/closing device illustrated in FIG. 1 is removed from the fragrance diffuser for a vehicle when viewed from above.

FIG. 3 is a view illustrating a right cut surface of FIG. 1 to show a state in which air and a fragrance flow along an internal space of a cartridge.

FIG. 4 is a view illustrating a right cut surface of FIG. 1 to show a state in which a control cam according to the exemplary embodiment of the present disclosure is connected to a shaft.

FIG. 5 is a view illustrating a right cut surface of FIG. 1 to show a state in which the internal space of the cartridge according to the exemplary embodiment of the present disclosure is opened.

FIG. 6 is a view illustrating a right cut surface of FIG. 1 to show a state in which the internal space of the cartridge according to the exemplary embodiment of the present disclosure is closed.

FIG. 7 is a view illustrating a front cut surface of FIG. 1 to show a state in which all of the internal spaces of the cartridges are closed by an opening/closing device according to the exemplary embodiment of the present disclosure.

FIG. 8 is a view illustrating a front cut surface of FIG. 1 to show a state in which only the internal space of the first cartridge is opened by the opening/closing device according to the exemplary embodiment of the present disclosure.

FIG. 9 is a view illustrating a front cut surface of FIG. 1 to show a state in which only the internal space of the second cartridge is opened by the opening/closing device according to the exemplary embodiment of the present disclosure.

FIG. 10 is a view illustrating a front cut surface of FIG. 1 to show a state in which only the internal space of the third cartridge is opened by the opening/closing device according to the exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of a fragrance diffuser for a vehicle according to the present disclosure will be described in detail with reference to the drawings. Terms or words used herein should not be interpreted as being limited to a general or dictionary meaning and should be interpreted as a meaning and a concept which conform to the technical spirit of the present disclosure based on a principle that an inventor can appropriately define a concept of a term in order to describe his/her own disclosure by the best method.

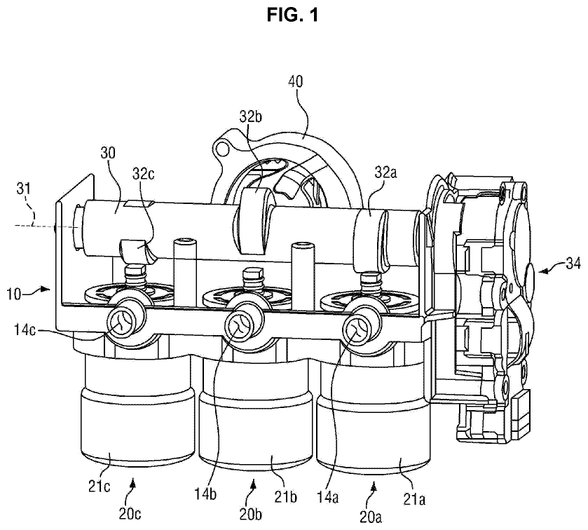

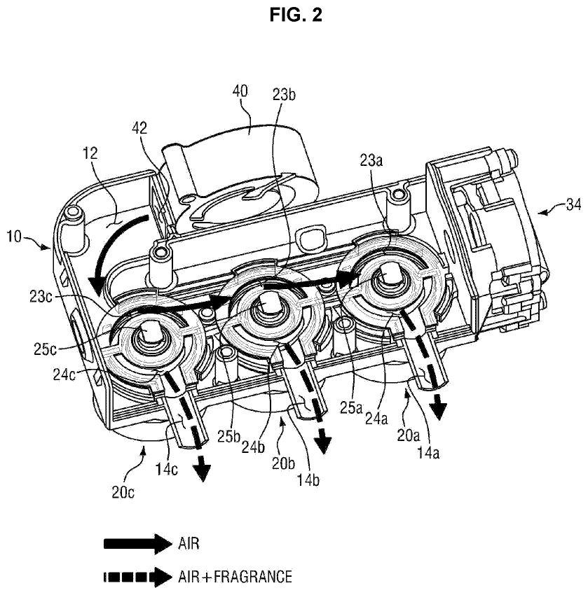

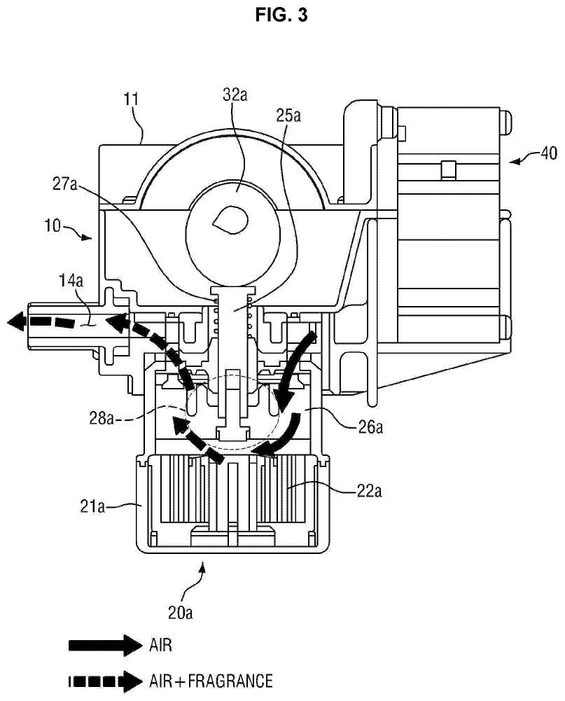

FIG. 1 is a view illustrating an overall appearance of a fragrance diffuser for a vehicle according to an exemplary embodiment of the present disclosure, FIG. 2 is a view illustrating a state in which an opening/closing device illustrated in FIG. 1 is removed from the fragrance diffuser for a vehicle when viewed from above, and FIG. 3 is a view illustrating a right cut surface of FIG. 1 to show a state in which air and a fragrance flow along an internal space of a cartridge. Meanwhile, for ease of description, FIGS. 1 and 2 illustrate states in which a cover unit 11 is removed from a housing 10.

Referring to FIGS. 1 and 2, the fragrance diffuser for a vehicle according to the exemplary embodiment of the present disclosure includes the housing 10, cartridges 20a, 20b, and 20c, an opening/closing device, and a control unit (not illustrated).

The housing 10 has a space in which an air discharge device, the cartridges 20a, 20b, and 20c, and the opening/closing device are mounted, and a space in which air and a fragrance flow. Meanwhile, the air discharge device according to the exemplary embodiment of the present disclosure is a blower 40, and the blower 40 is separately provided from an HVAC (heating, ventilation, air conditioning) blower (not illustrated) in a vehicle.

The blower 40 is mounted at one side of the housing 10. An inlet 12, through which air supplied from a discharge port 42 of the blower 40 is introduced into the housing 10, is formed at a portion adjacent to the blower 40.

A movement passage for the air is formed inside the housing 10, and insertion ports, into which the cartridges 20a, 20b, and 20c are inserted, are formed in the movement passage for the air. In the exemplary embodiment of the present disclosure, the plurality of insertion ports is provided. Meanwhile, FIGS. 1 to 10 illustrate states in which the cartridges 20a, 20b, and 20c are inserted, and thus it is not difficult for those skilled in the art to ascertain the positions of the insertion ports from FIGS. 1 to 10.

Referring to FIG. 3, the cartridges 20a, 20b, and 20c include casings 21a, 21b, and 21c, internal spaces formed in the casings 21 to store fragrances 22a, 22b, and 22c, and opening/closing members connected to the casings 21a, 21b, and 21c so as to open or close the internal spaces while elastically moving.

Meanwhile, the plurality of cartridges is provided. However, in the present specification, it is described that the three cartridges 20a, 20b, and 20c are provided and inserted into the housing 10. In this case, the cartridges 20a, 20b, and 20c are constituted by the same elements except that the different fragrances 22a, 22b, and 22c are stored in the cartridges 20a, 20b, and 20c, respectively. That is, FIG. 3 illustrates the first cartridge 20a, but the second and third cartridges 20b and 20c also have the same elements as the first cartridge 20a.

First opening/closing holes 23a, 23b, and 23c, through which the air in the housing 10 may be introduced into the internal spaces, are each formed at one side of each of the casings 21a, 21b, and 21c, and second opening/closing holes 24a, 24b, and 24c, through which the air in the internal spaces may be discharged to the outside of the housing 10, are each formed at the other side of each of the casings 21a, 21b, and 21c.

In the exemplary embodiment of the present disclosure, the opening/closing members include plungers 25a, 25b, and 25c and movable members 26a, 26b, and 26c. One end of each of the plungers 25a, 25b, and 25c is connected to each of the movable members 26a, 26b, and 26c in each of the casings 21a, 21b, and 21c, and the other end of each of the plungers 25a, 25b, and 25c is exposed to the outside of each of the casings 21a, 21b, and 21c. Springs 27a, 27b, and 27c are each connected between the other end of each of the plungers 25a, 25b, and 25c and each of the casings 21a, 21b, and 21c. Therefore, when the plungers 25a, 25b, and 25c are pressed, the movable members 26a, 26b, and 26c may be elastically moved by elastic force of the springs 27a, 27b, and 27c in a direction (pressing direction) toward the inside of the casings 21a, 21b, and 21c. When the pressure applied to the plungers 25a, 25b, and 25c is released, the movable members 26a, 26b, and 26c may be elastically moved by elastic restoring force in a direction (pressure releasing direction) toward the outside of the casings 21a, 21b, and 21c.

When the plungers 25a, 25b, and 25c and the movable members 26a, 26b, and 26c are moved in the pressing direction, separation spaces 28a, 28b, and 28c are formed between the casings 21a, 21b, and 21c and the movable members 26a, 26b, and 26c. In this case, the separation spaces 28a, 28b, and 28c and the internal spaces communicate with one another through holes (not illustrated) formed in the movable members 26a, 26b, and 26c. Therefore, flow paths are formed so that the air introduced into the casings 21a, 21b, and 21c through the first opening/closing holes 23a, 23b, and 23c may be introduced into the separation spaces 28a, 28b, and 28c and the internal spaces, and the air mixed with the fragrances 22a, 22b, and 22c in the internal spaces may be discharged along the separation spaces 28a, 28b, and 28c through the second opening/closing holes 24a, 24b, and 24c.

Meanwhile, sizes of the separation spaces 28a, 28b, and 28c may be changed in accordance with a magnitude of pressing force applied to the plungers 25a, 25b, and 25c. The concentration of the fragrances 22a, 22b, and 22c discharged through the second opening/closing holes 24a, 24b, and 24c may be determined depending on the sizes of the separation spaces 28a, 28b, and 28c.

The air mixed with the fragrances 22a, 22b, and 22c discharged from the second opening/closing holes 24a, 24b, and 24c may flow to the outside through outlets 14a, 14b, and 14c formed in the housing 10. In this case, the plurality of outlets 14a, 14b, and 14c is formed at positions corresponding to the second opening/closing holes 24a, 24b, and 24c formed in the cartridges 20a, 20b, and 20c, respectively.

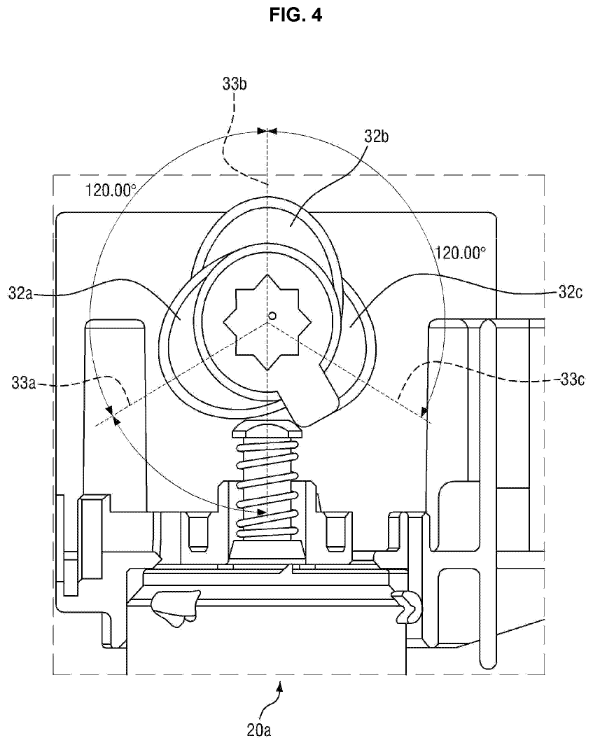

FIG. 4 is a view illustrating a right cut surface of FIG. 1 to show a state in which a control cam according to the exemplary embodiment of the present disclosure is connected to a shaft.

Referring to FIGS. 1 to 4, the opening/closing device configured to operate the opening/closing members is mounted at the other side of the housing 10. In the exemplary embodiment of the present disclosure, the opening/closing device includes a shaft 30, control cams 32a, 32b, and 32c, and an actuator 34.

The shaft 30 is positioned above the cartridges 20a, 20b, and 20c, and both ends of the shaft 30 are connected to the housing 10 so that the shaft 30 may be rotated about a rotation axis 31. The actuator 34 configured to provide rotational force to the shaft 30 is mounted in the housing 10. The actuator 34 may rotate the shaft 30 in a forward or reverse direction.

The control cams 32a, 32b, and 32c are connected to the shaft 30 to press or release the plungers 25a, 25b, and 25c exposed to the outside of the casings 21a, 21b, and 21c. The control cams 32a, 32b, and 32c include cam shafts 33a, 33b, and 33c serving as central axes, respectively, and the cam shafts 33a, 33b, and 33c are connected, at different angles, to the shaft 30. In the exemplary embodiment of the present disclosure, the three control cams 32a, 32b, and 32c are provided, and the cam shafts 33a, 33b, and 33c have an angle of 120° sequentially in a rotation direction of the shaft 30. That is, as illustrated in FIG. 4, in a clockwise direction based on the shaft 30, an angle between the first cam shaft 33a and the second cam shaft 33b is 120°, and an angle between the second cam shaft 33b and the third cam shaft 33c is 120°.

However, the angles between the cam shafts 33a, 33b, and 33c may be sequentially or non-sequentially different from one another in the rotation direction of the shaft 30. Further, the angles between the cam shafts 33a, 33b, and 33c may be set to be different from one another. In addition, in accordance with the number of cartridges 20a, 20b, and 20c, the number of control cams 32a, 32b, and 32c may be changed, and the angles between the cam shafts 33a, 33b, and 33c may also be set to be different from one another.

Meanwhile, the angles formed between the respective cam shafts 33a, 33b, and 33c are set considering both a first rotated state and a second rotated state which are rotated states of the shaft 30. The first rotated state refers to a state in which none of the control cams 32a, 32b, and 32c presses the corresponding plungers 25a, 25b, and 25c. The second rotated state refers to a state in which when any one of the control cams 32a, 32b, and 32c presses one of the corresponding plungers 25a, 25b, and 25c, the others of the control cams 32a, 32b, and 32c do not press the others of the corresponding plungers 25a, 25b, and 25c. A process of operating the opening/closing device according to the exemplary embodiment of the present disclosure will be described below.

The control unit controls the actuator 34 to rotate the shaft 30 to the first rotated state or the second rotated state. In addition, the control unit may receive a signal provided by a user to emit any one of the fragrances 22a, 22b, and 22c or to emit none of the fragrances 22a, 22b, and 22c, and thus the control unit may produce a control signal. In addition, the control unit may produce a control signal in order to adjust angles at which the control cams 32a, 32b, and 32c press the plungers 25a, 25b, and 25c, respectively. In addition, the control unit may control the actuator 34 by recognizing a discharge pattern of the fragrances 22a, 22b, and 22c desired by the user or recognizing the set time for which the fragrances 22a, 22b, and 22c are discharged.

Meanwhile, a memory unit (not illustrated) may be connected to the control unit. The memory unit (not illustrated) may collect information about the first rotated state and the second rotated state of the shaft 30 and information about the rotation of the shaft 30 desired by the user, and may store various programs for the control operation of the control unit based on the collected information.

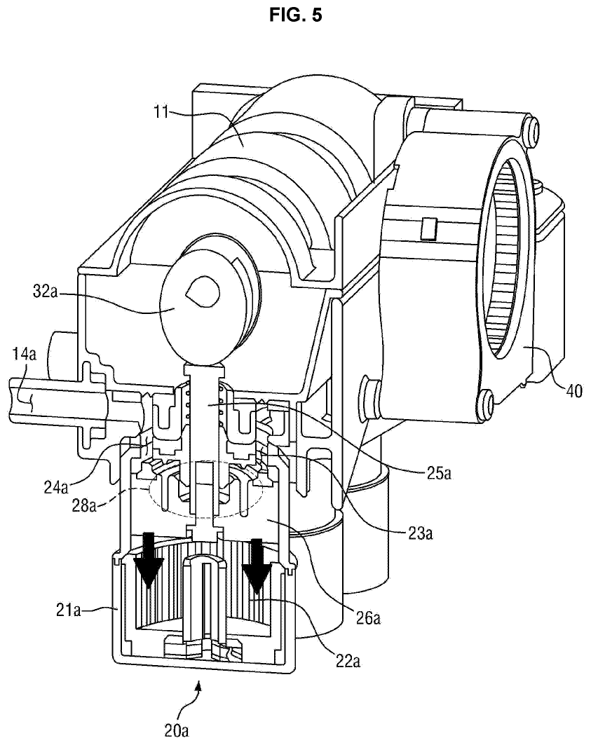

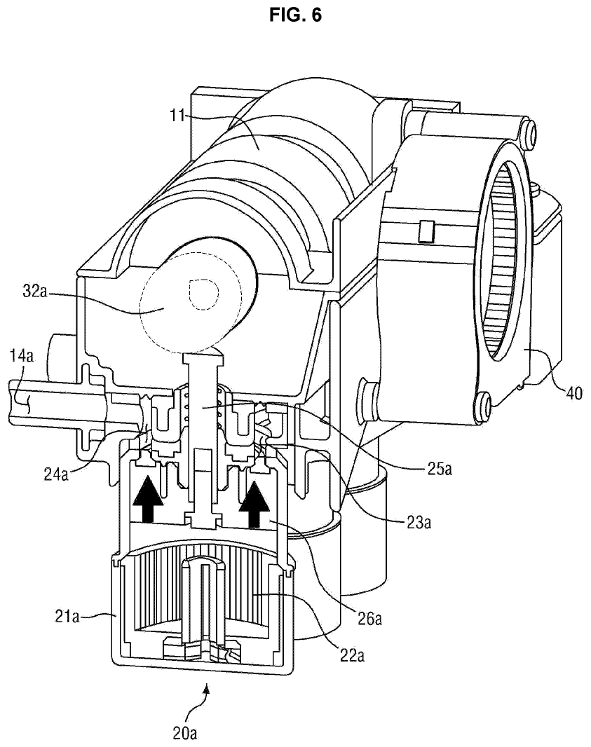

FIG. 5 is a view illustrating a right cut surface of FIG. 1 to show a state in which the internal space of the cartridge according to the exemplary embodiment of the present disclosure is opened, and FIG. 6 is a view illustrating a right cut surface of FIG. 1 to show a state in which the internal space of the cartridge according to the exemplary embodiment of the present disclosure is closed.

Hereinafter, the process of operating the opening/closing device will be described with reference to FIGS. 5 and 6.

Referring to FIG. 5, when the control cam 32a presses the plunger 25a, the movable member 26a is moved downward in the pressing direction, such that the separation space 28a is formed between the casing 21a and the movable member 26a. In this case, the flow path is formed, such that the air supplied from the blower 40 may be introduced into the internal space of the cartridge 20a through the first opening/closing hole 23a and then discharged to the outlet 14a through the second opening/closing hole 24a.

On the contrary, when the control cam 32a is rotated and the pressure applied to the plunger 25a is released, the movable member 26a is moved upward in the releasing direction, such that the separation space 28a between the casing 21a and the movable member 26a is eliminated. In this case, no fragrance can be discharged through the corresponding cartridge 20a.

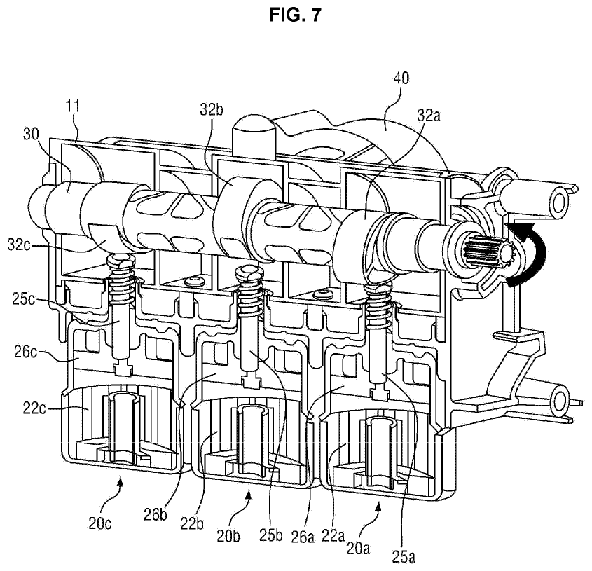

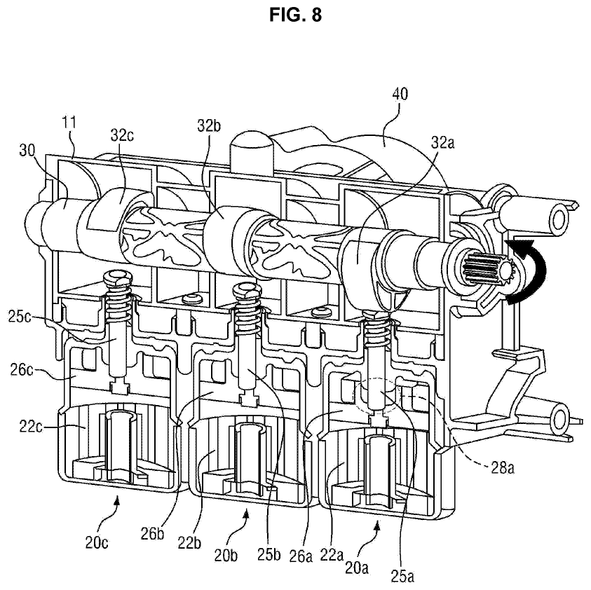

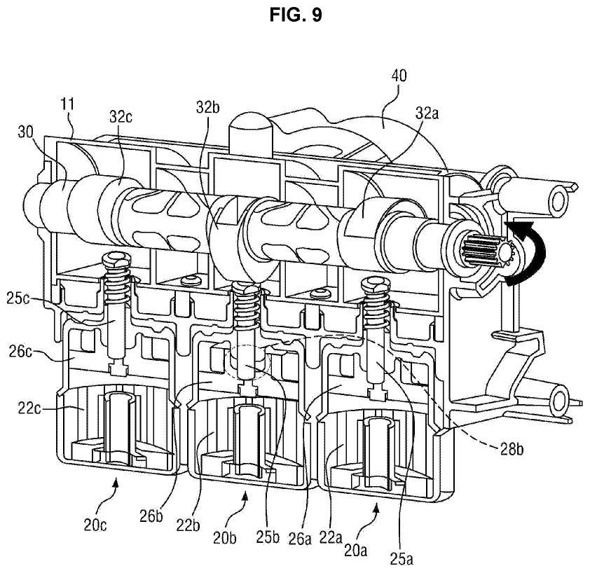

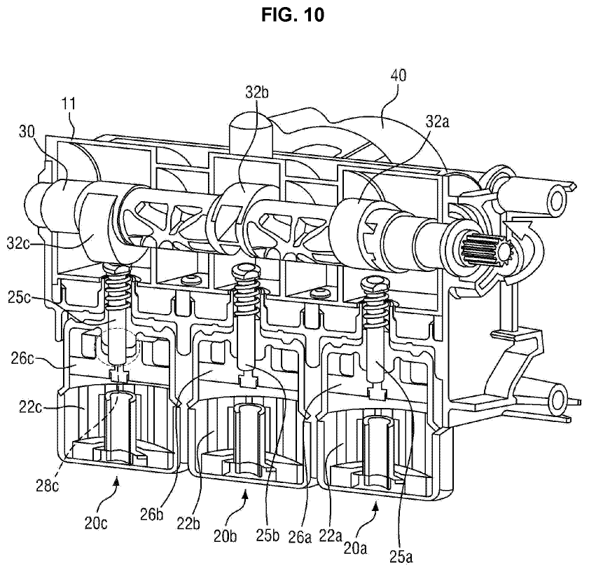

FIG. 7 is a view illustrating a front cut surface of FIG. 1 to show a state in which all of the internal spaces of the cartridges are closed by the opening/closing device according to the exemplary embodiment of the present disclosure, FIG. 8 is a view illustrating a front cut surface of FIG. 1 to show a state in which only the internal space of the first cartridge is opened by the opening/closing device according to the exemplary embodiment of the present disclosure, FIG. 9 is a view illustrating a front cut surface of FIG. 1 to show a state in which only the internal space of the second cartridge is opened by the opening/closing device according to the exemplary embodiment of the present disclosure, and FIG. 10 is a view illustrating a front cut surface of FIG. 1 to show a state in which only the internal space of the third cartridge is opened by the opening/closing device according to the exemplary embodiment of the present disclosure.

Meanwhile, for ease of description, FIGS. 7 to 10 illustrate states in which the actuator 34 is removed.

Hereinafter, a process of operating the fragrance diffuser for a vehicle according to the exemplary embodiment of the present disclosure will be described with reference to FIGS. 7 to 10.

Referring to FIG. 7, when the shaft 30 rotates and becomes in the first rotated state, none of the control cams 32a, 32b, and 32c presses the plungers 25a, 25b, and 25c. Then, since the internal spaces of the cartridges 20a, 20b, and 20c are not opened, none of the fragrances 22a, 22b, and 22c can be discharged.

Referring to FIG. 8, when the shaft 30 rotates counterclockwise by a predetermined angle and becomes in the second rotated state for the first time, the first control cam 32a presses the plunger 25a to open the first cartridge 20a. In this case, the second control cam 32b is distant at an angle of 120° from the first control cam 32a, and the third control cam 32c is distant at an angle of 240° from the first control cam 32a, such that the second control cam 32b and the third control cam 32c do not press the corresponding plungers 25b and 25c. Therefore, because the second cartridge 20b and the third cartridge 20c are not opened, only the first fragrance 22a stored in the first cartridge 20a is discharged. In this case, in a state in which the first control cam 32a fully presses the plunger 25a, the discharged first fragrance 22a has the maximum concentration. In this state, the concentration of the discharged first fragrance 22a may be adjusted in accordance with the extent to which the pressed state is decreased by rotating the first control cam 32a in the forward or reverse direction.

Referring to FIG. 9, when the shaft 30 rotates counterclockwise by a predetermined angle from the state illustrated in FIG. 8 and becomes in the second rotated state for the second time, the second control cam 32b presses the plunger 25b to open the second cartridge 20b. In this case, the third control cam 32c and the first control cam 32a are distant at an angle of 120° from the second control cam 32b, such that the first control cam 32a and the third control cam 32c do not press the corresponding plungers 25a and 25c, respectively. Therefore, because the first cartridge 20a and the third cartridge 20c are not opened, only the second fragrance 22b stored in the second cartridge 20b is discharged. In this case, the process of adjusting the concentration of the second fragrance 22b is as described above.

Referring to FIG. 10, when the shaft 30 rotates counterclockwise by a predetermined angle from the state illustrated in FIG. 9 and becomes in the second rotated state for the third time, the third control cam 32c presses the plunger 25c to open the third cartridge 20c. As can be derived from the above description, in this case, only the third cartridge 20c is opened, and only the third fragrance 22c is discharged. In this case, the process of adjusting the concentration of the second fragrance 22c is as described above.

The present disclosure has been described with reference to the limited exemplary embodiments and the drawings, but the present disclosure is not limited thereto. The described exemplary embodiments may be variously changed or modified by those skilled in the art to which the present disclosure pertains within the technical spirit of the present disclosure and within the scope equivalent to the appended claims.

What is claimed is:

1. A fragrance diffuser for a vehicle, the fragrance diffuser comprising:
a plurality of cartridges each comprising:
a casing having an internal space configured to store a fragrance; and
an opening/closing member extending to communicate with an interior and an exterior of the casing and configured to open or close the internal space depending on a moved state of the opening/closing member;
a housing comprising:
an inlet into which air is introduced by a blower mounted at one side of the housing;
a movement passage for the air; and
an outlet from which the fragrance or the air is discharged depending on an opened or closed state of each of the cartridges;
an opening/closing device configured to operate the opening/closing members; and
a control unit configured to control an operation of the opening/closing device.

2. The fragrance diffuser of claim 1, wherein each of the opening/closing members comprises:
a plunger; and
a movable member connected to one end of the plunger in the internal space and configured to open or close a flow path through which the air flows into or out of the casing.

3. The fragrance diffuser of claim 2, wherein a spring is provided on the plunger and supported on the casing to apply elastic force.

4. The fragrance diffuser of claim 2, wherein a separation space is formed between the casing and the movable member, and a size of the separation space is adjusted in accordance with a magnitude of pressing force applied to the plunger.

5. The fragrance diffuser of claim 1, wherein the casing is formed with a first opening/closing hole through which the air is introduced into the internal space, and a second opening/closing hole through which the air introduced into the first opening/closing hole is discharged from the internal space to the outlet.

6. The fragrance diffuser of claim 1, wherein the plurality of outlets is formed at positions corresponding to the respective cartridges.

7. The fragrance diffuser of claim 1, wherein the opening/closing device comprises:
a shaft;
a plurality of control cams connected to the shaft and configured to press or release the opening/closing members, respectively; and
an actuator configured to rotate the shaft.

8. The fragrance diffuser of claim 7, wherein the respective control cams are connected, at different angles, to the shaft so that when any one of the opening/closing members is pressed in a first rotated state of the shaft, other ones of the opening/closing members are not pressed.

9. The fragrance diffuser of claim 7, wherein the respective control cams are connected, at different angles, to the shaft so that none of the opening/closing members is pressed in a second rotated state of the shaft.

10. The fragrance diffuser of claim 1, wherein the control unit controls the opening/closing device to operate only one of the opening/closing members or to operate none of the opening/closing members.
